(19) United States
(12) Patent Application Publication
(10) Pub. No.: US 2026/0106079 A1
(43) Pub. Date: Apr. 16, 2026

(54) MULTILAYER CERAMIC CAPACITOR

(71) Applicant: SAMSUNG ELECTRO-MECHANICS CO., LTD., Suwon-si (KR)

(72) Inventors: Hyejin Park, Suwon-si (KR); Byungwoo Kang, Suwon-si (KR); Seung-Hun Han, Suwon-si (KR); Jungmin Kim, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/078,068

(22) Filed: Mar. 12, 2025

(30) Foreign Application Priority Data
Oct. 15, 2024 (KR) 10-2024-0140479
Dec. 4, 2024 (KR) 10-2024-0178635

(51) Int. Cl. H01G 4/232; H01G 4/30

(52) U.S. Cl. CPC H01G 4/2325; H01G 4/30

(57) ABSTRACT

A multilayer ceramic capacitor includes a body comprising: a plurality of internal electrodes and a dielectric layer disposed between the plurality of internal electrodes; and an external electrode disposed outside of the body. The external electrode includes an electrode layer connected to the plurality of internal electrodes and comprising a first metal and a glass; a plating layer disposed on the electrode layer, and a conductive inclusion disposed at an interface of the electrode layer and the plating layer.

### CROSS-REFERENCE TO RELATED APPLICATION

This application claims priority to and the benefit of Korean Patent Application Nos. 10-2024-0140479 filed on Oct. 15, 2024 and 10-2024-0178635 filed on Dec. 4, 2024, in the Korean Intellectual Property Office, the entire contents of which are incorporated herein by reference.

### BACKGROUND

### 1. Field

The present disclosure relates to a multilayer ceramic capacitor.

### 2. Description of the Related Art

An electronic component that uses a ceramic material includes a capacitor, an inductor, a piezoelectric element, a varistor, a thermistor, or the like. Among the ceramic electronic components, multilayer ceramic capacitor (MLCC) may be used in various electronic devices due to its advantages of being small, having high-capacity, and being easy to mount.

For example, a multilayer ceramic capacitor may be mounted on substrates of various electronic products such as an imaging device such as a liquid crystal display device (LCD), a plasma display device panel (PDP), an organic light-emitting diode (OLED), or the like, a computer, a personal portable terminal, and a smartphone so that the multilayer ceramic capacitor is used as a chip-type condenser that plays a role in charging or discharging electricity therein or therefrom.

The multilayer ceramic capacitor may include an internal electrode disposed inside a main body and an external electrode that is disposed outside the main body and is connected to the internal electrode. A paste containing metal and glass is applied to the main body and then fired to form an electrode layer, and an external electrode may be formed by forming a plating layer on the electrode layer. If the electrode layer is too thin or the conductive paste is overfired, the glass may exudate onto a surface of the electrode layer, which may cause plating breakage.

### SUMMARY

One aspect of an embodiment is to provide a multilayer ceramic capacitor including an external electrode with reduced plating breakage.

However, problems to be solved by embodiments of the present disclosure are not limited to the above-described problem and may be variously extended in a range of a technical idea included in the present disclosure.

A multilayer ceramic capacitor according to an embodiment may include: a body comprising a plurality of internal electrodes and a dielectric layer disposed between the plurality of internal electrodes; and an external electrode disposed outside of the body. The external electrode may include: an electrode layer connected to the plurality of internal electrodes and comprising a first metal and a glass; a plating layer disposed on the electrode layer; and a conductive inclusion disposed at an interface of the electrode layer and the plating layer.

The conductive inclusion may have an island shape.

The conductive inclusion may include a metal particle or a metal layer

The metal particle or the metal layer may include a second metal.

The conductive inclusion may include an intermetallic compound.

The conductive inclusion may include a conductive connection portion including a metal particle or a metal layer, and a first interface layer disposed at an interface of the conductive connection portion and the plating layer, and the first interface layer may include a first intermetallic compound.

The first intermetallic compound may include copper (Cu) and tin (Sn).

The first intermetallic compound may include Cu₆Sn₅ and/or Cu₃Sn.

The first intermetallic compound may include silver (Ag) and tin (Sn).

The first intermetallic compound may include Ag₃Sn.

The first intermetallic compound may include nickel (Ni) and tin (Sn).

The first intermetallic compound may include Ni₃Sn.

The conductive inclusion may include a conductive connection portion including a metal particle or a metal layer, and a second interface layer disposed at an interface of the conductive connection portion and the electrode layer, and the second interface layer may include a second intermetallic compound.

The second intermetallic compound may include copper (Cu) and tin (Sn).

The second intermetallic compound may include Cu₆Sn₅ and/or Cu₃Sn.

The second intermetallic compound may include gold (Au) and tin (Sn).

The second intermetallic compound may include AuSn₄, AuSn₂ or AuSn.

The second intermetallic compound may include lead (Pb) and bismuth (Bi).

The second intermetallic compound may include Pb₇Bi₃.

The conductive inclusion may include a conductive connection portion including a metal particle or a metal layer, and a resin being in contact with the conductive connection portion.

The conductive connection portion may be dispersed in the resin.

A length ratio of the conductive inclusion may be greater than 0% and less than or equal to 84.86%.

The body may include a first surface and a second surface opposite each other in a first direction intersecting the plurality of internal electrodes, and the electrode layer may include a connection portion connected to the plurality of internal electrodes, and a band portion extending from the connection portion and covering a portion of the first surface and a portion of the second surface.

The external electrode may further include a conductive resin layer covering at least a portion of the band portion, and the plating layer covers the conductive resin layer.

The electrode layer may include a corner portion where the connection portion and two band portions adjacent to the connection portion are connected to each other, and the conductive resin layer may cover the corner portion.

The external electrode may further include a residual conductive resin layer disposed in an island shape on the connection portion.

When a surface of the connection portion is uniformly divided into nine regions, the conductive resin layer may cover at least a portion of the connection portion in the region including the corner portion.

The conductive resin layer may extend from the band portion to the connection portion and covers a portion of the connection portion.

When a surface of the connecting portion is uniformly divided into nine regions, the conductive resin layer may cover at least a portion of the connection portion in the remaining region except for a central region.

A multilayer ceramic capacitor according to an embodiment may include: a body comprising a plurality of internal electrodes and a plurality of dielectric layers stacked in a first direction; and an external electrode disposed outside of the body, and the external electrode may include: an electrode layer connected to the plurality of internal electrodes and having a recess on a surface thereof; a conductive inclusion filling the recess; and a plating layer covering the electrode layer and the conductive inclusion.

In a cross-section along the first direction, the conductive inclusion may include an inner portion in contact with the electrode layer and an outer portion in contact with the plating layer, with reference to a straight line connecting a first point and a second point where the electrode layer, the plating layer, and the conductive inclusion meet each other. An area of the inner portion may be larger than an area of the outer portion.

In a cross-section along the first direction, the conductive inclusion may include an inner portion in contact with the electrode layer and an outer portion in contact with the plating layer, with reference to a straight line connecting a first point and a second point where the electrode layer, the plating layer, and the conductive inclusion meet each other. A maximum distance between the straight line and an edge of the inner portion may be greater than a maximum distance between the straight line and an edge of the outer portion.

According to the multilayer ceramic capacitor according to the embodiment, by forming a conductive inclusion on surface of an electrode layer of an external electrode and then forming a plating layer, plating breakage may be prevented.

### BRIEF DESCRIPTION OF THE DRAWINGS

FIG. 1 is a perspective view schematically showing a multilayer ceramic capacitor according to an embodiment.

FIG. 2 is a cross-sectional view taken along line I-I′ of FIG. 1.

FIG. 3 is an exploded perspective view showing a stacked structure of internal electrodes in the multilayer ceramic capacitor of FIG. 1.

FIG. 4 shows an example of an enlarged view of region A of FIG. 2.

FIG. 5 shows another example of an enlarged view of region A of FIG. 2.

FIG. 6 shows another example of an enlarged view of region A of FIG. 2.

FIG. 7 is a schematic view for describing a process of forming the conductive inclusion of the multilayer ceramic capacitor according to an embodiment.

FIG. 8 is a schematic view for describing a process of forming the conductive inclusion of the multilayer ceramic capacitor according to an embodiment.

FIG. 9 is a schematic view for describing a process of forming the conductive inclusion of the multilayer ceramic capacitor according to an embodiment.

FIG. 10 is a schematic view for describing a process of forming the conductive inclusion and the plating layer of the multilayer ceramic capacitor according to an embodiment.

FIG. 11 is an image of a cross-section of a central portion of the external electrode in the thickness direction (T) of the multilayer ceramic capacitor according to an embodiment, taken using a scanning electron microscope (SEM).

FIG. 12 is an image showing a measurement area E in FIG. 11.

FIG. 13 is a colored image of a region where the conductive inclusion is formed in the measurement area E.

FIG. 14 is a black-and-white image of the measurement area E.

FIG. 15 is a schematic view for describing a method of measuring the length ratio of the first conductive inclusion in the measurement area E.

FIG. 16 is a perspective view schematically showing a multilayer ceramic capacitor according to another embodiment.

FIG. 17 is a cross-sectional view taken along line II-II′ of FIG. 16.

FIG. 18 is a cross-sectional view taken along line III-III′ of FIG. 16.

FIG. 19 is a drawing schematically showing the first external electrode of the multilayer ceramic capacitor of FIG. 16.

FIG. 20 is a drawing schematically showing the second external electrode of the multilayer ceramic capacitor of FIG. 16.

FIG. 21 is a drawing schematically showing the first external electrode of the multilayer ceramic capacitor of FIG. 16.

FIG. 22 is a drawing schematically showing the first external electrode of the multilayer ceramic capacitor according to another embodiment.

FIG. 23 is a drawing schematically showing the first external electrode of the multilayer ceramic capacitor according to another embodiment.

FIG. 24 is a drawing schematically showing the first external electrode of the multilayer ceramic capacitor according to another embodiment.

FIG. 25 is a drawing schematically illustrating the first external electrode of the multilayer ceramic capacitor according to another embodiment.

### DETAILED DESCRIPTION

Hereinafter, various embodiments of the present disclosure will be described in detail so that a person of ordinary skill in the technical field to which the present disclosure belongs can easily implement it with reference to the accompanying drawings. In order to clearly describe the present disclosure, parts or portions that are irrelevant to the description are omitted in the drawings, and identical or similar constituent elements throughout the specification are denoted by the same reference numerals. In addition, some constituent elements in the accompanying drawings are exaggerated, omitted, or schematically illustrated, and the size of each constituent element does not fully reflect the actual size.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various components, and are not to be interpreted as limiting these components. The terms are only used to differentiate one component from other components.

It will be understood that when an element such as a layer, film, region, area, or substrate is referred to as being “on” or “above” another element, it may be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

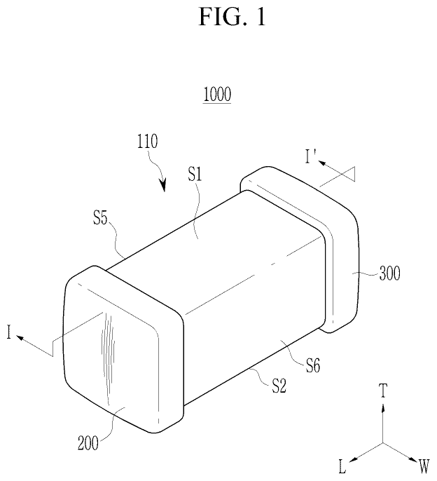

FIG. 1 is a perspective view schematically showing a multilayer ceramic capacitor according to an embodiment.

Referring to FIG. 1, the multilayer ceramic capacitor 1000 according to the embodiment includes a body 110, a first external electrode 200, and a second external electrode 300.

First, direction are defined to clearly describe the embodiment. A T-axis, an L-axis, and a W-axis shown in the drawings represent a first direction, a second direction, and a third direction of the multilayer ceramic capacitor 1000, respectively.

The first direction (T) may be a direction perpendicular to a wide surface (a major surface) of constituent elements having a sheet shape. For example, the first direction (T) may be used as the same concept as a direction in which dielectric layers 140 are stacked. Hereinafter, when necessary, the first direction may be referred to as a “thickness direction.”

The second direction (L) may be a direction parallel to the wide surface (the main surface) of the constituent elements having a sheet shape and be a direction (T) that intersects (or is perpendicular to) the thickness direction (T). For example, the second direction (L) may be a direction in which the first external electrode 200 and the second external electrode 300 oppose each other. Hereinafter, when necessary, the second direction may be referred to as a “length direction.”

The third direction (W) may be a direction parallel to the wide surface (the main surface) of the constituent elements having a sheet shape, and be a direction (T) that intersects (or is perpendicular to) both of the first direction (T) and the second direction (L). Hereinafter, when necessary, the third direction may be referred to as a “width direction.”

The body 110 may have a roughly hexahedral shape, but the present embodiment is not limited thereto. Due to shrinkage during sintering, the body 110 may not have a perfect hexahedral shape, and may have a substantially hexahedral shape. For example, the body 110 may have a substantially rectangular parallelepiped shape, and a portion corresponding to a corner or a vertex may have a rounded shape.

In the present embodiment, for ease of explanation, surfaces opposing each other in the thickness direction (T) of the body 110 are defined as a first surface S1 and a second surface S2, surfaces opposing each other in the length direction (L) of the body 110 and connecting the first surface S1 and the second surface S2 are defined as a third surface S3 and a fourth surface S4, and surfaces opposing each other in the width direction (W) of the body 110 and connecting the first surface S1 and the second surface S2 are defined as a fifth surface S5 and a sixth surface S6.

Therefore, the first direction (T) in which the first surface S1 and the second surface S2 oppose each other may be the thickness direction (T), and the second and third directions perpendicular to the first direction and perpendicular to each other may be the length direction (L) and the width direction (W) or the width direction (W) and the length direction (L), respectively.

A length of the body 110 may mean a maximum value among a plurality of lengths of line segments connecting two outermost boundary lines opposing each other in the length direction (L) of the body 110 shown in a photograph of a cross-section and parallel to the length direction (L). The photograph of the cross-section may be an optical microscope photograph or a scanning electron microscope (SEM) photograph of a length direction (L)-thickness direction (T) cross-section at a central portion of the body 110 in the width direction (W). Meanwhile, the length of the body 110 may mean a minimum value among the plurality of lengths of line segments connecting the two outermost boundary lines opposing each other in the length direction (L) of the body 110 shown the photograph of the cross-section and parallel to the length direction (L). The length of the body 110 may mean an arithmetic average value of lengths of at least two line segments among the line segments connecting the two outermost boundary lines opposing each other in the length direction (L) of the body 110 shown the photograph of the cross-section and parallel to the length direction (L).

A thickness of the body 110 may mean a maximum value among a plurality of lengths of line segments connecting two outermost boundary lines opposing each other in the thickness direction (T) of the body 110 shown in a photograph of a cross-section and parallel to the thickness direction (T). The photograph of the cross-section may be the optical microscope photograph or the scanning electron microscope (SEM) photograph of the length direction (L)-thickness direction (T) cross-section at the central portion of the body 110 in the width direction (W). Meanwhile, the thickness of the body 110 may mean a minimum value among the plurality of lengths of line segments connecting the two outermost boundary lines opposing each other in the thickness direction (T) of the body 110 shown in the photograph of the cross-section and parallel to the thickness direction (T). The thickness of the body 110 may mean an arithmetic average value of lengths of at least two line segments among the line segments connecting the two outermost boundary lines opposing each other in the thickness direction (T) of the body 110 shown in the photograph of the cross-section and parallel to the thickness direction (T).

A width of the body 110 may mean a maximum value among a plurality of lengths of line segments connecting two outermost boundary lines opposing each other in the width direction (W) of the 110 shown in a photograph of a cross-section and parallel to the width direction (W). The photograph of the cross-section may be an optical microscope photograph or a scanning electron microscope (SEM) photograph of a length direction (L)-width direction (W) cross-section at a central portion of the body 110 in the thickness direction (T). Meanwhile, the width of the body 110 may mean a minimum value among the plurality of lengths of line segments connecting the two outermost boundary lines opposing each other in the width direction (W) of the body 110 shown in the photograph of the cross-section and parallel to the width direction (W). The width of the 110 may mean an arithmetic average value of lengths of at least two line segments among the lengths of line segments connecting the two outermost boundary lines opposing each other in the width direction (the W-axis direction) of the body 110 shown in the photograph of the cross-section and parallel to the width direction (W).

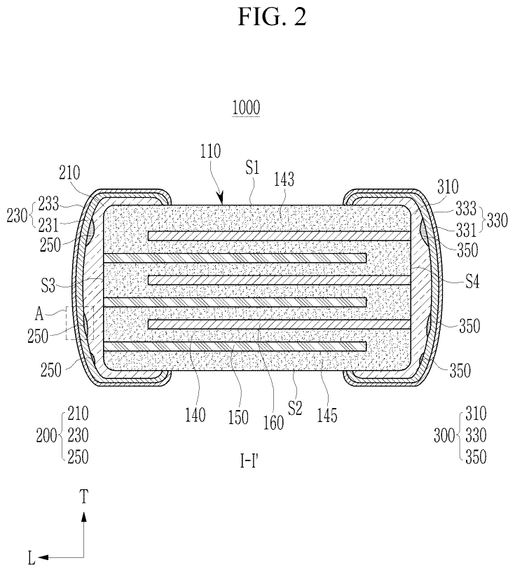

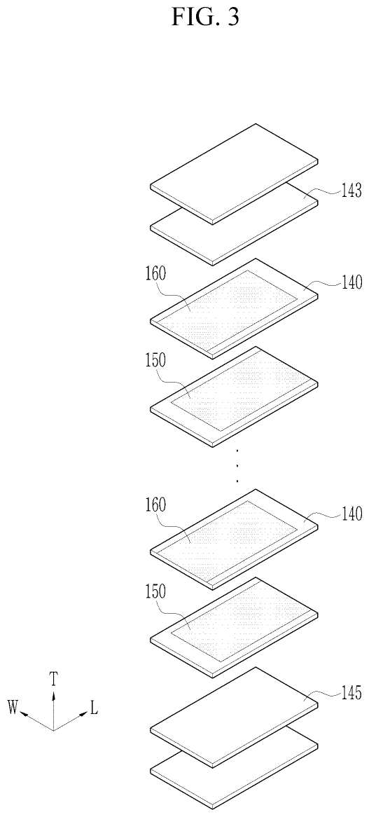

FIG. 2 is a cross-sectional view taken along line I-I′ of FIG. 1, and FIG. 3 is an exploded perspective view showing a stacked structure of internal electrodes in the multilayer ceramic capacitor of FIG. 1.

Referring to FIG. 2 and FIG. 3, the body 110 may include a plurality of dielectric layers 140, at least one first internal electrode 150, and at least one second internal electrode 160.

The plurality of dielectric layers 140 are stacked in the thickness direction (T) of the body 110. Boundaries between the dielectric layers 140 may be unclear. For example, it is difficult to observe the boundaries between the dielectric layers 140 without using a scanning electron microscope (SEM), and the plurality of dielectric layers 140 may appear to have an integral structure.

The dielectric layer 140 may include a ceramic material. For example, the ceramic material may include dielectric ceramic including components such as BaTiO₃, CaTiO₃, SrTiO₃, or CaZrO₃. Also, the dielectric layer may further include an auxiliary component such as at least one selected from the group consisting of a manganese (Mn) compound, an iron (Fe) compound, a chromium (Cr) compound, a cobalt (Co) compound, a nickel (Ni) compound, and combinations thereof, or the like, in addition to the ceramic material. For example, the dielectric layer may include (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved into BaTiO₃, but the present disclosure is not limited thereto.

Additionally, the dielectric layer 140 may further include one or more selected from the group consisting of ceramic additives, organic solvents, plasticizers, binders, and dispersants. Examples of the ceramic additive may include transition metal oxides or carbides, rare earth elements, magnesium (Mg), aluminum (Al), or the like.

The first internal electrode 150 and the second internal electrode 160 may be alternately stacked with the dielectric layer 140 interposed therebetween. This stack structure may be repeated inside the body 110, the internal electrode closest to the first surface S1 of the body 110 may be the first internal electrode 150 or the second internal electrode 160, and the internal electrode closest to the second surface S2 of the body 110 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to offset from each other in the length direction (L) with the dielectric layer 140 interposed therebetween. One end of the first internal electrode 150 may be exposed through the third surface S3 of the body 110, and one end of the second internal electrode 160 may be exposed through the fourth surface S4 of the body 110. The end of the first internal electrode 150 exposed from the third surface S3 of body 110 may be connected to the first external electrode 200. The end of the second internal electrode 160 exposed from the fourth surface S4 of body 110 may be connected to the second external electrode 300.

The first internal electrode 150 and the second internal electrode 160 may be formed by printing a conductive paste that includes a metal on a surface of the dielectric layer 140. For example, a conductive paste including nickel (Ni) or nickel (Ni) alloy may be printed on the surface of the dielectric layer using screen printing or gravure printing to form the internal electrode. However, the embodiment is not limited thereto.

When a voltage is applied to the first external electrode 200 and the second external electrode 300, an electric charge may accumulate between the first internal electrode 150 and the second internal electrode 160. That is, capacitance may be generated between the first internal electrode 150, which is electrically connected to the first external electrode 200, and the second internal electrode 160, which is electrically connected to the second external electrode 300. Capacitance of the multilayer ceramic capacitor 1000 may be proportional to an area where the first internal electrode 150 and the second internal electrode 160 overlap each other along the thickness direction (T).

In some embodiments of the present disclosure, a first cover layer 143 and a second cover layer 145 may be disposed on the outermost side of body 110 in the thickness direction (T).

The first cover layer 143 may be disposed between the first surface S1 of the body 110 and the internal electrode closest to the first surface S1 of the body 110. The second cover layer 145 may be disposed between the second surface S2 of the body 110 and the internal electrode closest to the second surface S2 of the body 110.

That is, within the body 110, the first cover layer 143 may be disposed at an upper portion of an uppermost internal electrode, and the second cover layer 145 may be disposed at a lower portion of a lowermost internal electrode

The first cover layer 143 and the second cover layer 145 may have the same composition as that of the dielectric layer 140. The first cover layer 143 and the second cover layer 145 may be formed by stacking one or more dielectric layers on an outer surface of the uppermost internal electrode and an outer surface of the lowermost internal electrode, respectively. Meanwhile, the first cover layer 143 and the second cover layer 145 may have different compositions from the dielectric layer 140.

The first cover layer 143 and the second cover layer 145 may serve to prevent damage to the first internal electrode 150 and the second internal electrode 160 by a physical or chemical stress.

In some embodiments of the present disclosure, the first external electrode 200 and the second external electrode 300 may be disposed outside the body 110

The first external electrode 200 may be disposed on the third surface S3 of the body 110, and may extend onto at least one of the first surface S1, the second surface S2, the fifth surface S5, or the sixth surface S6. The second external electrode 300 may be disposed on the fourth surface S4 of the body 110, and may extend onto at least one of the first surface S1, the second surface S2, the fifth surface S5, or the sixth surface S6.

In some embodiments, the first external electrode 200 may include a first electrode layer 210, a first plating layer 230, and a first conductive inclusion 250.

The first electrode layer 210 may cover the third surface S3 of the body 110 and be electrically connected to the exposed ends of the plurality of first internal electrodes 150. The first electrode layer 210 may extend from the third surface S3 of the body 110 and cover a portion of at least one of the third surface S3, the fourth surface S4, the fifth surface S5, and the sixth surface S6.

The first electrode layer 210 may include metal and glass.

The metal included in the first electrode layer 210 may include at least one selected from the group consisting of nickel (Ni), copper (Cu), palladium (Pd), gold (Au) and an alloy thereof, but the embodiment is not limited thereto.

The glass included in the first electrode layer 210 may include SiO₂-based or B₂O₃-based glass, and include both SiO₂ and B₂O₃, but the embodiment is not limited thereto.

The first electrode layer 210 may include a baked electrode formed by applying a conductive paste including a metal and glass to the third surface S3 of the body 110 and then baking it. The glass included in the conductive paste may be in the form of glass frit.

In some embodiments of the present disclosure, the first plating layer 230 may be disposed on the first electrode layer 210.

The first plating layer 230 may include a first layer 231 and a second layer 233. The first layer 231 may be disposed on the first electrode layer 210, and the second layer 233 may be disposed on the first layer 231. The first layer 231 may include nickel (Ni), and the second layer 233 may include tin (Sn), but the embodiment is not limited thereto.

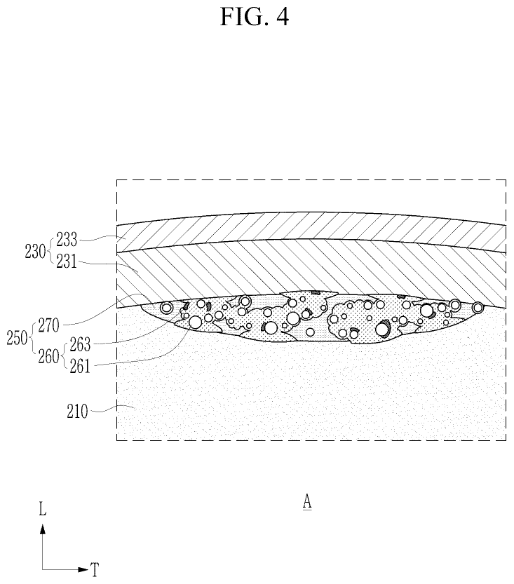

FIG. 4 shows an example of an enlarged view of region A of FIG. 2.

Referring to FIG. 2 and FIG. 4, the first conductive inclusion 250 may be disposed at the interface of the first electrode layer 210 and the first plating layer 230.

The first conductive inclusion 250 may be discontinuously disposed at the interface between the first electrode layer 210 and the first plating layer 230. For example, the first conductive inclusion 250 may be disposed in the shape of a plurality of islands. In some embodiments, the first conductive inclusion 250 may be disposed in the first electrode layer 210 and extending the boundary between the first electrode layer 210 and the first plating layer 230 toward the first plating layer 230.

The first conductive inclusion 250 may include a first conductive connection portion 260 and a first resin 270.

For example, the first resin 270 may include any of the various known thermosetting resins, such as an epoxy resin, a phenolic resin, a urethane resin, a silicone resin, or a polyimide resin.

Meanwhile, the first resin 270 may include a metal as a filler. For example, the filler may include at least one selected from the group consisting of copper (Cu), silver (Ag), nickel (Ni), tin (Sn) and alloys thereof.

The first conductive connection portion 260 may include a plurality of metal particles (or metal layers) 261 and an intermetallic compound (IMC) 263.

Th plurality of metal particles (or metal layers) 261 may include at least one selected from the group consisting of copper (Cu), silver (Ag), nickel (Ni), tin (Sn) and an alloy thereof, but the embodiment is not limited thereto. For example, the metal particles or metal layers of the first conductive connection portion 160 may include a metal different from the metal included in the first electrode layer 210.

The intermetallic compound 263 refers to a compound in which two or more metals are combined in a simple integer ratio. The intermetallic compound may be formed by a reaction between a high-melting-point metal and a low-melting-point metal included in the conductive resin composition forming the first conductive inclusion 250. Here, the high-melting-point metal may include at least one selected from the group consisting of copper (Cu), silver (Ag), silver (Ag)-coated copper (Cu), tin (Sn)-coated copper (Cu), and nickel (Ni), and the low-melting-point metal may include at least one selected from the group consisting of tin (Sn), a tin (Sn) alloy, bismuth (Bi), and a bismuth (Bi) alloy. The intermetallic compound may comprise CuₓSn_{y}, wherein x is an integer from 1 to 6, and y is an integer of 1 to 5, and x>y). The intermetallic compound may comprise NiₓSn, wherein x is an integer from 1 to 3. The intermetallic compound may comprise AgₓSn, wherein x is an integer from 1 to 3. The intermetallic compound formed in this manner may include at least one selected from the group consisting of Cu₆Sn₅, Cu₃Sn, Ni₃Sn, and Ag₃Sn. Bismuth (Bi) does not directly form intermetallic compounds, but may serve to lower the melting point of tin (Sn) during the intermetallic compound formation process. That is, as the content of bismuth (Bi) increases, the melting point of tin (Sn) may decrease. Meanwhile, after the intermetallic compound is formed, the remaining low melting point metal and the intermetallic compound may be included in the first conductive connection portion 260. That is, the first conductive connection portion 260 may include a low melting point metal having a melting point lower than a curing temperature of the first resin 270. For example, the low melting point metal may have a melting point of 300° C. or lower, and more specifically, a melting point ranging from 200° C. to 250° C.

Meanwhile, in another embodiments, the first conductive inclusion 250 may comprise a metal particle or a metal layer. In this case, the first conductive inclusion 250 does not include the first resin 270.

In some embodiments, the first conductive inclusion 250 may not include a metal oxide. In some embodiments, the first conductive inclusion 250 may not include aluminum (Al), magnesium (Mg), manganese (Mn), nickel (Ni), lithium (Li), silicon (Si), titanium It or alloys thereof.

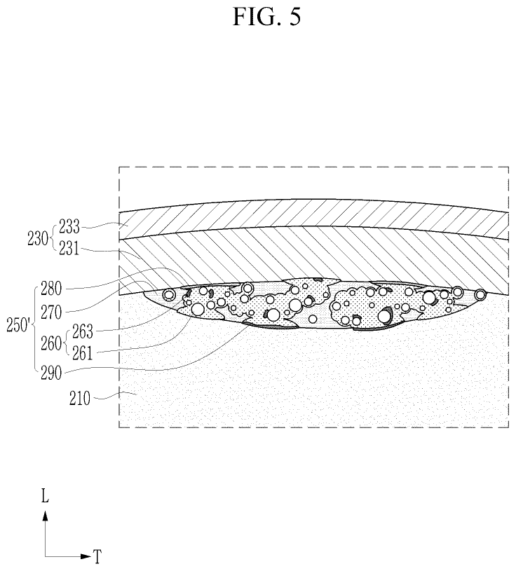

FIG. 5 shows another example of an enlarged view of region A of FIG. 2.

Referring to FIG. 5, the first conductive inclusion 250′ may further include a first interface layer 280 and a second interface layer 290 in addition to the first conductive connection portion 260 and the first resin 270.

In some embodiments of the present disclosure, the first interface layer 280 may be disposed at the interface of the first conductive connection portion 260 and the first plating layer 230. The first interface layer 280 may include a first intermetallic compound formed by a reaction between a metal included in the first conductive connection portion 260 and a metal included in the first plating layer 230.

The first interface layer 280 may include copper (Cu) and/or tin (Sn), for example, Cu₆Sn₅ and/or Cu₃Sn. The first interface layer 280 may include silver (Ag) and/or tin (Sn), for example, Ag₃Sn. The first interface layer 280 may include nickel (Ni) and/or tin (Sn), for example, Ni₃Sn.

In some embodiments of the present disclosure, the second interface layer 290 may be disposed at the interface of the first conductive connection portion 260 and the first electrode layer 210. The second interface layer 290 may include a second intermetallic compound formed by a reaction between a metal included in the first conductive connection portion 260 and a metal included in the first electrode layer 210.

The second interface layer 290 may include copper (Cu) and/or tin (Sn), for example, Cu₆Sn₅ and/or Cu₃Sn. The second interface layer 290 may include gold (Au) and/or tin (Sn), for example, AuSn₄, AuSn₂ or AuSn. The second interface layer 290 may include lead (Pb) and/or bismuth (Bi), for example, Pb₇Bi₃.

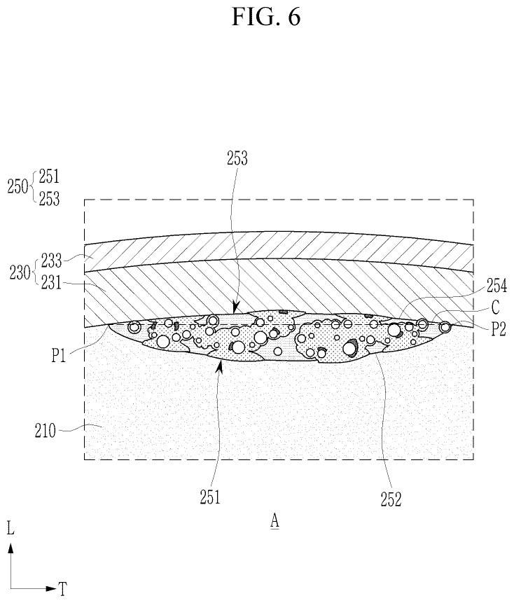

FIG. 6 shows another example of an enlarged view of region A of FIG. 2.

Referring to FIG. 6, the first conductive inclusion 250 may include an inner portion 251 and an outer portion 253.

The inner portion 251 and the outer portion 253 may be distinguished based on a straight line C connecting a first point P1 and a second point P2 where the first electrode layer 210, the first plating layer 230, and the first conductive inclusion 250 meet each other.

The inner portion 251 is an area including a portion where the first conductive inclusion 250 contacts the first electrode layer 210 with respect to the straight line C. The inner portion 251 may be an area surrounded by the straight line C and an interface 252 between the first conductive inclusion 250 and the first electrode layer 210.

The outer portion 253 is an area including a portion where the first conductive inclusion 250 contacts the first plating layer 230 with respect to the straight line C. That is, the outer portion 253 may be an area surrounded by the straight line C and an interface 254 between the first conductive inclusion 250 and the first plating layer 230.

An area of the inner portion 251 may be larger than an area of the outer portion 253.

Here, the area of the inner portion 251 and the area of the outer portion 253 may be measured based on an optical microscope photograph or a scanning electron microscope (SEM) photograph of a cross-section taken along the length direction (L)-thickness direction (T) at a central portion of the multilayer ceramic capacitor 1000 in the width direction (W). By measuring the cross-sectional image described above using a Scanning Electron Microscope-Energy Dispersive X-ray Spectroscopy (hereinafter referred to as “SEM-EDX”), the area of the inner portion 251 and the area of the outer portion 253 may be obtained.

In addition, using known image analysis software, the area of the inner portion 251 and the area of the outer portion 253 shown in the aforementioned cross-section photograph may be accurately measured.

Meanwhile, a first maximum distance between the straight line C and an edge of the inner portion 251 in the Length direction may be greater than a second maximum distance between the straight line C and an edge of the outer portion 253 in the Length direction.

Here, the first maximum distance and the second maximum distance may be measured based on an optical microscope photograph or a scanning electron microscope (SEM) photograph of a cross-section taken along the length direction (L)-thickness direction (T) at a central portion of the multilayer ceramic capacitor 1000 in the width direction (W)

In the cross-sectional photograph described above, the maximum value of the lengths of a plurality of line segments that are orthogonal to the straight line C connecting the first point P1 and the second point P2 where the first conductive inclusion, the first electrode layer, and the first plating layer meet each other and pass through the interface 252 between the first conductive inclusion and the first electrode layer may be the first maximum distance. In addition, in the cross-sectional photograph described above, the maximum value of the lengths of a plurality of line segments that are orthogonal to the straight line C connecting the first point P1 and the second point P2 where the first conductive inclusion, the first electrode layer, and the first plating layer meet each other and pass through the interface 254 between the first conductive inclusion and the first plating layer may be the second maximum distance.

As described above, the area of the inner portion 251 may be larger than the area of the outer portion 253, and the first maximum distance between the straight line C and the edge of the inner portion 251 may be larger than the second maximum distance between the straight line C and the edge of the outer portion 253.

That is, with reference to the straight line C, the first conductive inclusion 250 may have a protruding shape toward both the first plating layer 230 and the first electrode layer 210, and may have a more protruding shape toward the first electrode layer 210.

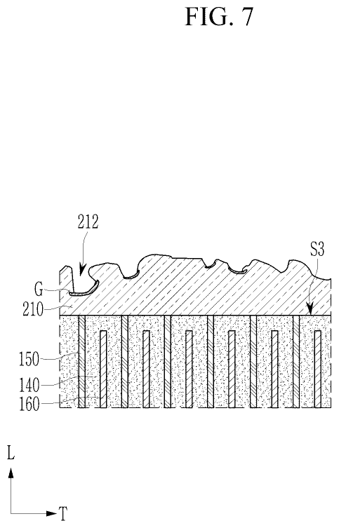

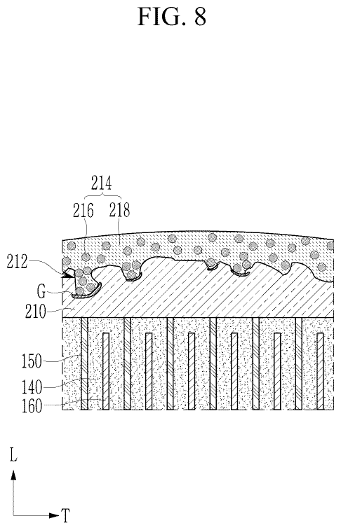

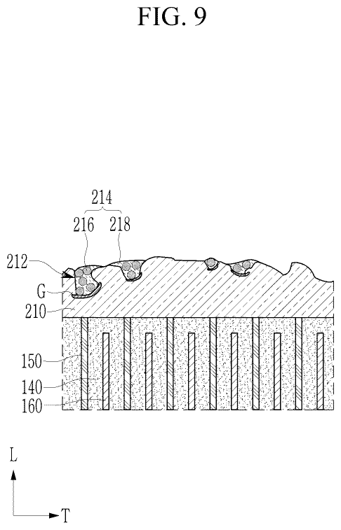

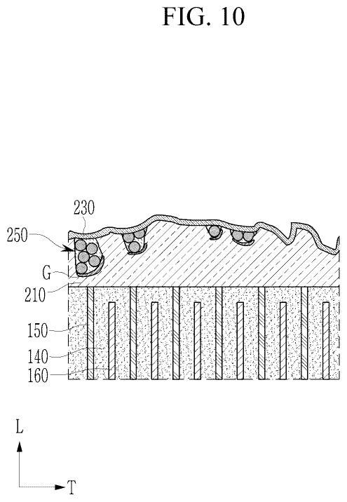

FIG. 7, FIG. 8, FIG. 9, and FIG. 10 are schematic view for describing a process of forming the conductive inclusion and the plating layer of the multilayer ceramic capacitor according to some embodiments of the present disclosure.

Referring to FIG. 7, a recess 212 exists on a surface of the first electrode layer 210. Accordingly, the surface of the first electrode layer 210 includes protrusions and depressions.

The first electrode layer 210 may be a baked electrode formed by applying a conductive paste including metal and glass to the third surface S3 of the body 110 and then baking it. In this case, a recess 212 is formed in the first electrode layer 210 during the firing process, and glass G inside the first electrode layer 210 may elute to the surface.

Since glass G is not electrically conductive, plating metal on the surface of the first electrode layer 210 in this state may result in insufficient plating, such as no plating layer forming in the recess 212, and plating breakage.

Referring to FIG. 8, a conductive resin composition 214 is applied to the surface of the first electrode layer 210. The conductive resin composition 214 may include a plurality of metal particles 216 and resin 218. The conductive resin composition 214 may cover the surface of the first electrode layer 210 and fill the recess 212. The metal particles 216 may also fill the recess 212 with the rein composition 214. Since the conductive resin composition 214 fills the recess 212, the unevenness of the surface of the first electrode layer 210 may be reduced. That is, the flatness of the surface of the first electrode layer 210 may be increased.

Referring to FIG. 9, the conductive resin composition 214 may be removed from the surface of the first electrode layer 210, leaving the conductive resin composition 214, which may include the metal particles 216, filling the recess 212. The conductive resin composition 214 is then subjected to a drying or curing process to form a first conductive inclusion 250 (see FIG. 10).

In some embodiments of the present disclosure, the first plating layer 230 may be formed as illustrated in FIG. 10. The first plating layer 230 may simultaneously cover the surface of the first electrode layer 210 and the first conductive inclusion 250 formed in the recess 212. Since the recess 212 is filled with the first conductive inclusion 250, the first plating layer 230 may be formed more easily than in a case where the glass is exposed. Additionally, since the first conductive inclusion 250 fills the recess 212, the unevenness of the surface of the first electrode layer 210 may be reduced and the flatness may be increased. Accordingly, the plating breakage of the first plating layer 230 may be reduced.

Meanwhile, a ratio of a length of the first conductive inclusion 250 in the thickness direction (T) to a length of an interface between the first electrode layer 210 and the first plating layer 230 (hereinafter, referred to as a “length ratio”) may be greater than 0% and less than or equal to 84.86%.

If the length ratio of the first conductive inclusion 250 exceeds 84.86%, plating breakage may occur.

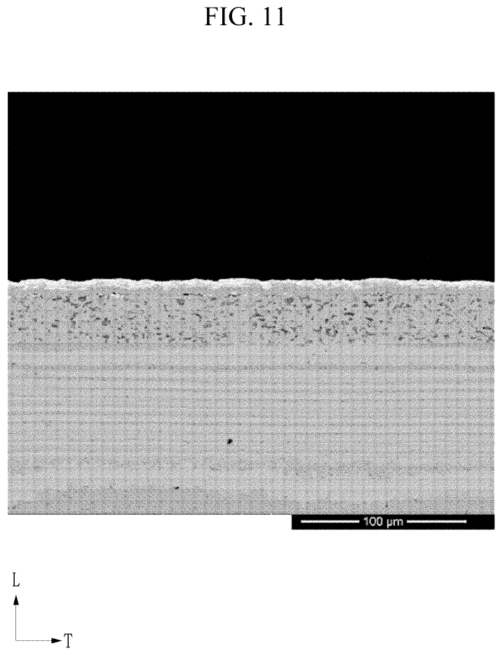

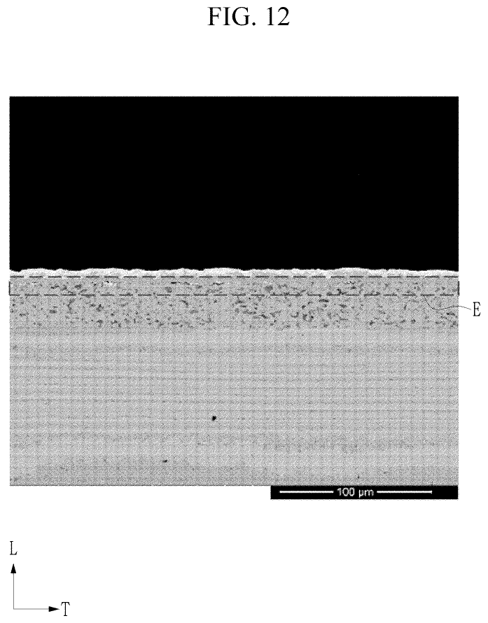

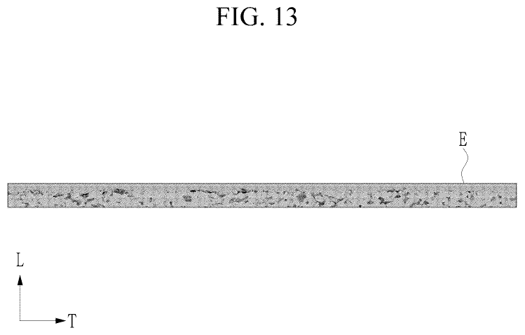

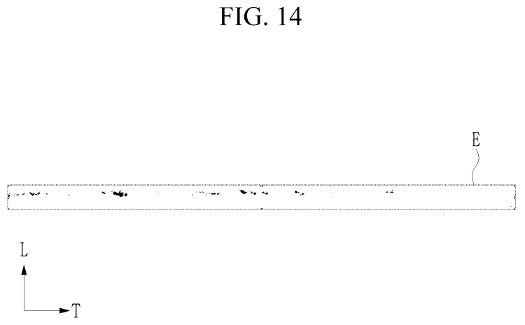

Hereinafter, referring to FIG. 10, FIG. 11, FIG. 12, FIG. 13, and FIG. 14, a method for measuring the length ratio of the first conductive inclusion will be described.

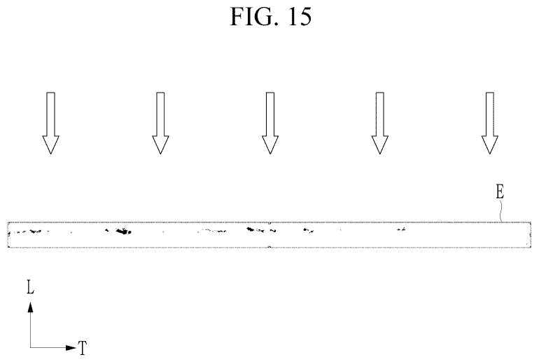

FIG. 11 is an image of a cross-section of a central portion of the external electrode including the first electrode layer 210 and the first plating layer 230 in the thickness direction (T) of the multilayer ceramic capacitor according to an embodiment, taken using a scanning electron microscope (SEM), and FIG. 12 is an image showing a measurement area E in FIG. 11. FIG. 13 is a grayscale image of a region where the conductive inclusion is formed in the measurement area E, and FIG. 14 is a black-and-white image of the measurement area E. FIG. 15 is a schematic view for describing a method for measuring the length ratio of the first conductive inclusion in the measurement area E.

The length ratio of the first conductive inclusion 250 is measured based on a scanning electron microscope (SEM) photograph (see FIG. 11) of a cross-section taken along the length direction (L)-thickness direction (T) at a central portion of the multilayer ceramic capacitor 1000 in the width direction (W). The length ratio of the first conductive inclusion 250 may be derived by measuring the size of the metal particle or the length of the resin layer that is present between the first electrode layer and the first plating layer at a central portion of the first external electrode 200 or the second external electrode 300 in the thickness direction (T) shown in the cross-section photograph described above. Referring to FIGS. 12 and 13, using an ImageJ program, the measurement area E having a length of 250 μm in the thickness direction (T) and a length of 20 μm in the length direction (L) may be obtained based on a central point of the first external electrode in the thickness direction (T) and length direction (L) shown in the cross-sectional photograph described above. The measurement area E is selected such that all of the first conductive inclusions formed at the interface between the first electrode layer and the first plating layer are visible. Referring to FIG. 14, the measurement area E is marked in black and white using the ImageJ program. That is, the first electrode layer and the first plating layer are marked in white, and the metal particles (or resin layer) that are present between the first electrode layer and the first plating layer are marked in black. Referring to FIG. 15, the region marked in black is projected in a direction perpendicular to the length of the measurement area E (in the direction of the arrow). Thereafter, the sum of the lengths of the projected portions divided by the total length of the measurement area E in the thickness direction (T) is taken as the length ratio of the first conductive inclusion.

The plating breakage is determined by peeling off the second layer 233 of the first plating layer 230 from the width direction W-thickness direction T surface of the first external electrode of the multilayer ceramic capacitor and taking a scanning electron microscope (SEM) photograph of the corresponding surface. If the maximum length of the exposed portion of the first electrode layer 210 on the surface of the first external electrode 200 shown in the above-mentioned photograph is 30 μm or more, it is determined that “plating breakage” has occurred. Meanwhile, through destructive physical analysis (DPA) of the multilayer ceramic capacitor, the second layer 233 (e.g., tin (Sn) plating layer) of the first plating layer 230 is removed, and the first layer 231 (e.g., nickel (Ni) plating layer) is exposed. Here, if the maximum length of the portion where the first electrode layer is exposed is 30 μm or more, or the maximum thickness of the first layer in the exposed portion is 30 μm or more, it is determined that a “plating breakage” has occurred.

The second external electrode 300 includes a second electrode layer 310, a second plating layer 330, and a second conductive inclusion 350.

The second electrode layer 310 covers the fourth surface S4 of the body 110 and is electrically connected to the exposed ends of a plurality of second internal electrodes 160. The second electrode layer 310 may extend from the fourth surface S4 of the body 110 and cover a portion of at least one of the first surface S1, the second surface S2, the fifth surface S5, and the sixth surface S6.

The fourth surface S4 of the body 110 may be dipped into a conductive paste including a metal (e.g., copper (Cu) or nickel (Ni)) and glass and then blotted to form the second electrode layer 310.

The second plating layer 330 is disposed on the second electrode layer 310.

The second plating layer 330 may include a third layer 331 and a fourth layer 333. The third layer 331 may be disposed on the second electrode layer 310, and the fourth layer 333 may be disposed on the third layer 331. The third layer 331 may include nickel (Ni) and the fourth layer 333 may include tin (Sn), but the embodiment is not limited thereto.

The second conductive inclusion 350 has the same or corresponding structure and function as the first conductive inclusion 250, except for its location, so a redundant description thereof will be omitted.

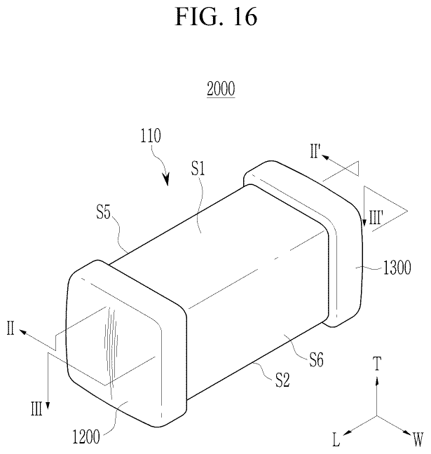

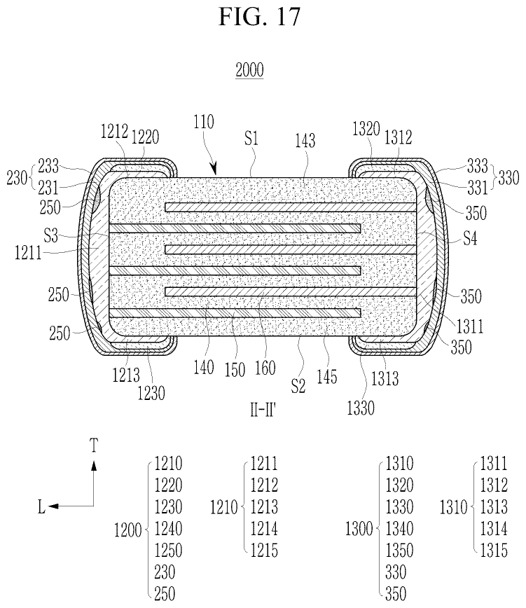

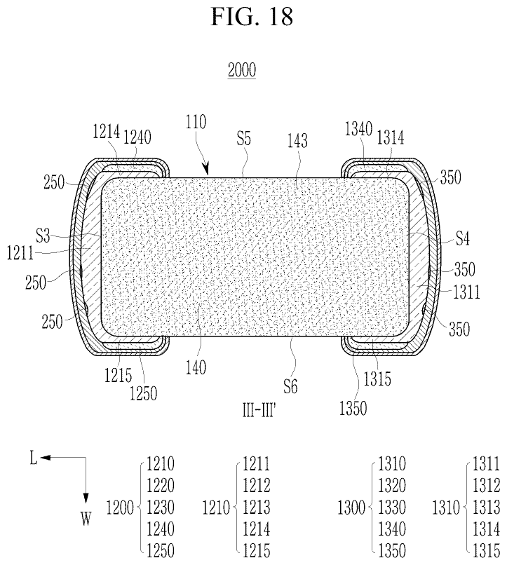

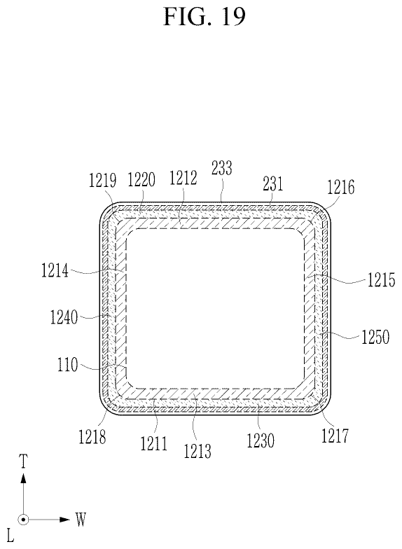

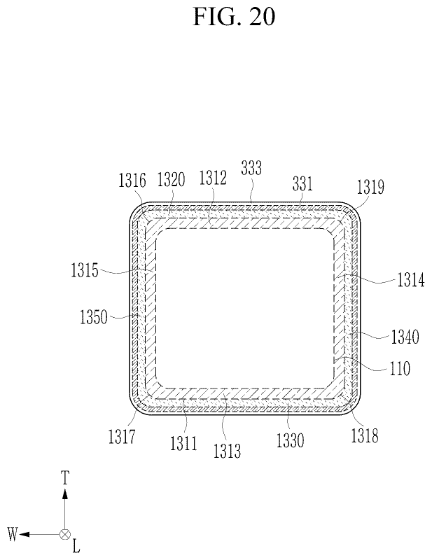

FIG. 16 is a perspective view schematically showing a multilayer ceramic capacitor according to another embodiments, FIG. 17 is a cross-sectional view taken along line II-II′ of FIG. 16, and FIG. 18 is a cross-sectional view taken along line III-III′ of FIG. 16. FIG. 19 is a drawing schematically showing the first external electrode of the multilayer ceramic capacitor of FIG. 16, and FIG. 20 is a drawing schematically showing the second external electrode of the multilayer ceramic capacitor of FIG. 16. For better understanding and ease of explanation, the first plating layer of the first external electrode is shown in part in FIG. 19, and the second plating layer of the second external electrode is shown in part in FIG. 20.

Referring to FIG. 16, FIG. 17, FIG. 18, FIG. 19, and FIG. 20, a multilayer ceramic capacitor 2000 includes a body 110, a first external electrode 1200, a second external electrode 1300, a plurality of first internal electrodes 150, and a plurality of second internal electrodes 160.

The first external electrode 1200 may include a first electrode layer 1210, a first conductive resin layer 1220, a second conductive resin layer 1230, a third conductive resin layer 1240, a fourth conductive resin layer 1250, a first plating layer 230, and a first inclusion 250.

The first electrode layer 1210 includes metal. For example, the first electrode layer 1210 may include one or more selected from the group consisting of silver (Ag), lead (Pb), platinum (Pt), nickel (Ni), copper (Cu), and alloys thereof.

The first electrode layer 1210 may include a first connection portion 1211, a first band portion 1212, a second band portion 1213, a third band portion 1214, a fourth band portion 1215, a first corner portion 1216, a second corner portion 1217, a third corner portion 1218, and a fourth corner portion 1219.

The first connection portion 1211 may cover the third surface S3 of the body 110 and may be electrically connected to the exposed ends of a plurality of first internal electrodes 150.

The first band portion 1212 may extend from the first connection portion 1211 and cover a portion of the first surface S1 of the body 110, and the second band portion 1213 may extend from the first connection portion 1211 and cover a portion of the second surface S2 of the body 110.

The third band portion 1214 may extend from the first connection portion 1211 and cover a portion of the fifth surface S5 of the body 110, and the fourth band portion 1215 may extend from the first connection portion 1211 and cover a portion of the sixth surface S6 of the body 110.

The first conductive resin layer 1220 may cover the first band portion 1212 and expose the first connection portion 1211. That is, the first conductive resin layer 1220 may be disposed on the first band portion 1212 and not on the first connection portion 1211, or may be partially disposed on the first connection portion 1211. For example, the first conductive resin layer 1220 may extend from the first band portion 1212 onto the first connection portion 1211 to cover a portion of the first connection portion 1211.

For example, the first conductive resin layer 1220 may cover a part or all of the first band portion 1212. Additionally, the first conductive resin layer 1220 may cover a portion of the first surface S1 of the body 110.

The second conductive resin layer 1230 may cover the second band portion 1213 and expose the first connection portion 1211. That is, the second conductive resin layer 1230 may be disposed on the second band portion 1213 and not on the first connection portion 1211, or may be partially disposed on the first connection portion 1211. For example, the second conductive resin layer 1230 may extend from the second band portion 1213 onto the first connection portion 1211 to cover a portion of the first connection portion 1211.

For example, the second conductive resin layer 1230 may cover part or all of the second band portion 1213. Additionally, the second conductive resin layer 1230 may cover a portion of the second surface S2 of the body 110.

The third conductive resin layer 1240 may cover the third band portion 1214 and expose the first connection portion 1211. That is, the third conductive resin layer 1240 may be disposed on the third band portion 1214 and not on the first connection portion 1211, or may be partially disposed on the first connection portion 1211. For example, the third conductive resin layer 1240 may extend from the third band portion 1214 onto the first connection portion 1211 to cover a portion of the first connection portion 1211.

For example, the third conductive resin layer 1240 may cover a part or all of the third band portion 1214. Additionally, the third conductive resin layer 1240 may cover a portion of the fifth surface S5 of body 110.

The fourth conductive resin layer 1250 may cover the fourth band portion 1215 and expose the first connection portion 1211

That is, the fourth conductive resin layer 1250 may be disposed on the fourth band portion 1215 and not on the first connection portion 1211, or may be partially disposed on the first connection portion 1211. For example, the fourth conductive resin layer 1250 may extend from the fourth band portion 1215 onto the first connection portion 1211 to cover a portion of the first connection portion 1211.

For example, the fourth conductive resin layer 1250 may cover a part or all of the fourth band portion 1215. Additionally, the fourth conductive resin layer 1250 may cover a portion of the sixth surface S6 of the body 110.

The first conductive resin layer 1220 may include a metal and resin.

For example, the metal included in the first conductive resin layer 1220 may include at least one selected from the group consisting of copper (Cu), silver (Ag), nickel (Ni), tin (Sn) and an alloy thereof.

For example, the resin included in the first conductive resin layer 1220 may include various known thermosetting resins, such as an epoxy resin, a phenol resin, a urethane resin, a silicone resin, and a polyimide resin.

After the first electrode layer 1210 is formed, a conductive resin composition including a metal powder and a thermosetting resin may be applied onto the first electrode layer 1210. Here, the thermosetting resin may be a bisphenol A resin, a glycol epoxy resin, a Novolac epoxy resin, or a resin which has a low molecular weight and is liquid at room temperature among derivatives thereof, but is not limited thereto. For example, the conductive resin composition may be prepared by mixing silver (Ag) powder, copper (Cu) powder, silver (Ag)-coated copper (Cu) powder, tin (Sn)-based solder powder, and a thermosetting resin, and then dispersing the mixture using a 3-roll mill. The tin (Sn)-based solder powder may include at least one selected from the group consisting of tin (Sn), Sn_{96.5}Ag_{3.0}Cu_{0.5}, Sn₄₂Bi₅₈, and Sn₇₂Bi₂₈, but the present disclosure is not limited thereto. Thereafter, the conductive resin composition on the first connection portion 1211 may be removed, and then, the first conductive resin layer 1220 may be formed on the first band portion 1212 through curing. Accordingly, the first connection portion 1211 may be disposed on the third surface S3 of the body 110, and the first band portion 1212 and the first conductive resin layer 1220 may be disposed on the first surface S1, the second surface S2, the fifth surface S5, and the sixth surface S6 of the body 110.

Unlike the present embodiment, if both the electrode layer and the resin layer covering the electrode layer are disposed on the third surface S3 of the body 110, the resin layer has lower electrical connectivity than the electrode layer, and thus equivalent series resistance (ESR) of the first external electrode may increase. There is also a risk of lifting due to out-gassing from the resin layer during a high-temperature reflow process. Furthermore, since the resin layer is present on the electrode layer, the external electrode may be thick and a relative volume of the body may be small compared to a case in which only the electrode layer is present, resulting in that the effective capacity of the multilayer ceramic capacitor is reduced.

On the other hand, according to the present embodiment, the first connection portion 1211 is disposed on the third surface S3 of the body 110, and the first conductive resin layer 1220 is not disposed on the third surface S3 of the body 110, and thus, the above-mentioned problem may not occur.

The second conductive resin layer 1230, the third conductive resin layer 1240, and the fourth conductive resin layer 1250 include the same or similar components as the first conductive resin layer 1220 described above, and thus repeated descriptions thereof will be omitted.

The first corner portion 1216 is a portion where the first connection portion 1211, the first band portion 1212, and the fourth band portion 1215 are connected to each other. That is, the first corner portion 1216 is a portion disposed at the corner where the first surface S1, the third surface S3, and the sixth surface S6 of the body 110 are connected to each other.

The second corner portion 1217 is a portion where the first connection portion 1211, the second band portion 1213, and the fourth band portion 1215 are connected to each other. That is, the second corner portion 1217 is a portion disposed at the corner where the second surface S2, the third surface S3, and the sixth surface S6 of the body 110 are connected to each other.

The third corner portion 1218 is a portion where the first connection portion 1211, the second band portion 1213, and the third band portion 1214 are connected to each other. That is, the third corner portion 1218 is a portion disposed at the corner where the second surface S2, the third surface S3, and the fifth surface S5 of the body 110 are connected to each other.

The fourth corner portion 1219 is a portion where the first connection portion 1211, the first band portion 1212, and the third band portion 1214 are connected to each other. That is, the fourth corner portion 1219 is a portion disposed at the corner where the first surface S1, the third surface S3, and the fifth surface S5 of the body 110 are connected to each other.

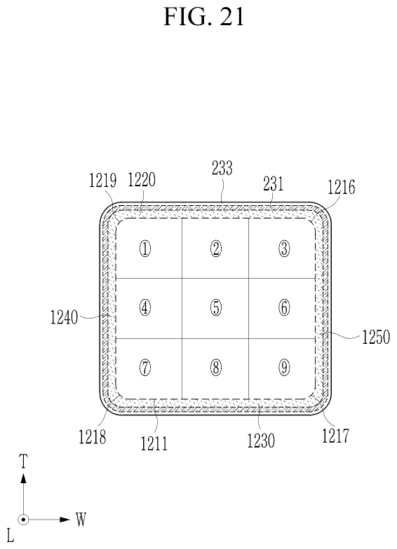

FIG. 21 is a drawing schematically showing the first external electrode of the multilayer ceramic capacitor of FIG. 16. For better understanding and ease of explanation, the first plating layer of the first external electrode is partially excluded and the remainder is illustrated.

Referring to FIG. 21, the surface of the first connection portion 1211 viewed in the length direction (L) may be trisected in each of the width direction (W) and the thickness direction (T) to be uniformly divided into nine regions. Here, each region may be defined as a region 1 in an upper portion in the thickness direction (T) and a left portion in the width direction (W), a region 2 in an upper portion in the thickness direction (T) and an intermediate portion in the width direction (W), a region 3 in an upper portion in the thickness direction (T) and a right portion in the width direction (W), a region 4 in an intermediate portion in the thickness direction (T) and a left portion in the width direction (W), a region 5 in an intermediate portion in the thickness direction (T) and an intermediate portion in the width direction (W), a region 6 in an intermediate portion in the thickness direction (T) and a right portion in the width direction (W), a region 7 in a lower portion in the thickness direction (T) and a left portion in the width direction (W), a region 8 in a lower portion in the thickness direction (T) and an intermediate portion in the width direction (W), and a region 9 in a lower portion in the thickness direction (T) and a right portion in the width direction (W).

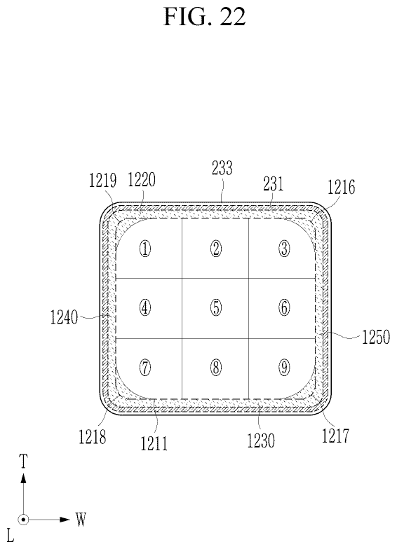

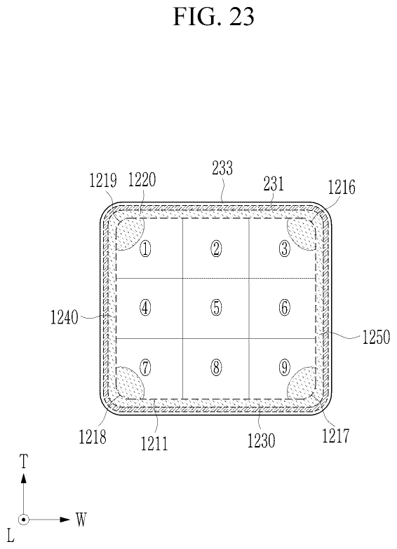

FIG. 22 is a drawing schematically showing the first external electrode of the multilayer ceramic capacitor according to another embodiment, and FIG. 23 is a drawing schematically showing the first external electrode of the multilayer ceramic capacitor according to another embodiment.

Referring to FIG. 22 and FIG. 23, the first conductive resin layer 1220 and the third conductive resin layer 1240 may extend from the first band portion 1212 and the third band portion 1214 to cover at least a portion of the region 1 in an upper portion in the thickness direction (T) and a left portion in the width direction (W). For example, the first conductive resin layer 1220 and the third conductive resin layer 1240 may cover at least a portion of the fourth corner portion 1219.

Additionally, the first conductive resin layer 1220 and the fourth conductive resin layer 1250 may extend from the first band portion 1212 and the fourth band portion 1215 to cover at least a portion of the region 3 in an upper portion in the thickness direction (T) and a right portion in the width direction (W). For example, the first conductive resin layer 1220 and the fourth conductive resin layer 1250 may cover at least a portion of the first corner portion 1216.

Additionally, the second conductive resin layer 1230 and the third conductive resin layer 1240 may extend from the second band portion 1213 and the third band portion 1214 to cover at least a portion of the region 7 in a lower portion in the thickness direction (T) and a left portion in the width direction (W). For example, the second conductive resin layer 1230 and the third conductive resin layer 1240 may cover at least a portion of the third corner portion 1218.

Additionally, the second conductive resin layer 1230 and the fourth conductive resin layer 1250 may extend from the second band portion 1213 and the fourth band portion 1215 to cover at least a portion of the region 9 in a lower portion in the thickness direction (T) and a right portion in the width direction (W). For example, the second conductive resin layer 1230 and the fourth conductive resin layer 1250 may cover at least a portion of the second corner portion 1217.

In this way, when the corner portions 1216, 1217, 1218, and 1219 of the first electrode layer 1210 are covered by the conductive resin layers 2220, 2230, 2240, and 2250, they are resistant to external impacts that may be applied in subsequent processes. Accordingly, plating breakage at the first, second, third, and fourth corners 1216, 1217, 1218, and 1219 may be prevented, and the reliability of the multilayer ceramic capacitor may be improved.

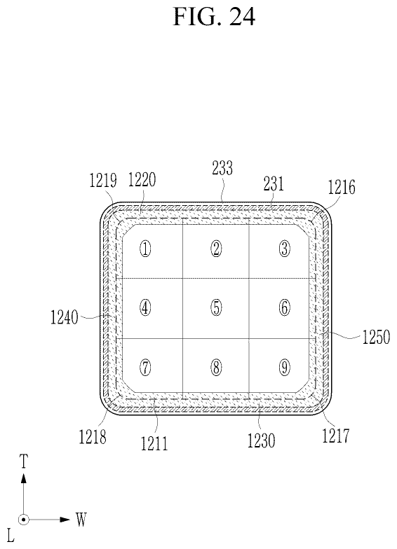

FIG. 24 is a drawing schematically showing the first external electrode of the multilayer ceramic capacitor according to another embodiment.

Referring to FIG. 24, the first conductive resin layer 1220, the second conductive resin layer 1230, the third conductive resin layer 1240, and the fourth conductive resin layer 1250 may extend from the first band portion 1212, the second band portion 1213, the third band portion 1214, and the fourth band portion 1215, respectively, to cover at least a portion of the remaining regions (1, 2, 3, 4, 6, 7, 8, 9) except the region 5 in an intermediate portion in in the thickness direction (T) and an intermediate portion in the width direction (W). For example, the edges where the first connection portion 1211 and the band portions 1212, 1213, 1214, and 1215 are connected may be covered by the conductive resin layers 1220, 1230, 1240, and 1250. In this case, the edges become resistant to external impacts that may be applied in subsequent processes. Accordingly, plating breakage on the edges where the first connection portion 1211 and the band portions 1212, 1213, 1214, 1215 are connected may be prevented, and the reliability of the multilayer ceramic capacitor may be improved.

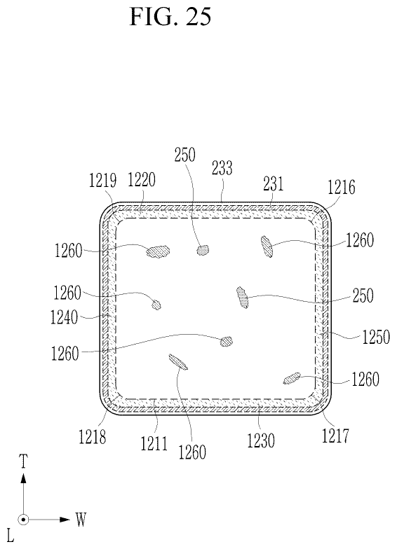

FIG. 25 is a drawing schematically illustrating the first external electrode of the multilayer ceramic capacitor according to another embodiment.

Referring to FIG. 25, a residual conductive resin layer 1260 may be disposed in the shape of a plurality of islands on the surface of the first connection portion 1211. The residual conductive resin layer 1260 may be present if the conductive resin composition on the first connection portion 1211 is not completely removed during the process of forming the conductive resin layer described above.

In particular, the conductive inclusion 250 may be formed if a portion of the residual conductive resin layer 1260 fills the recess 212 of the first connection 1211 (see FIG. 7). That is, the residual conductive resin layer 1260 and the conductive inclusion 250 may be present on the first connection portion 1211. In this case, the conductive inclusion 250 may include the same components as the first conductive resin layer 1220, the second conductive resin layer 1230, the third conductive resin layer 1240, and the fourth conductive resin layer 1250.

In another embodiment, if all of the residual conductive resin layer 1260 fills the recess of the first connection portion 1211, no residual conductive resin layer 1260 may be present on the first connection portion 1211 and only the conductive inclusion 250 may be present.

The present disclosure is not limited to the embodiments described above, and thus embodiments combining the embodiments shown in FIG. 20, FIG. 21, FIG. 22, or FIG. 23 with the embodiments shown in FIG. 24 are also possible.

Except for the components described above, the remaining components are identical to or correspond to the components of the multilayer ceramic capacitor shown in FIG. 1, and therefore, a repeated description thereof will be omitted.

The second external electrode 1300 may include a second electrode layer 1310, a fifth conductive resin layer 1320, a sixth conductive resin layer 1330, a seventh conductive resin layer 1340, an eighth conductive resin layer 1350, a second plating layer 330, and a second conductive inclusion 350.

The second electrode layer 1310 includes metal. For example, the second electrode layer 1310 may include one or more of silver (Ag), lead (Pb), platinum (Pt), nickel (Ni), copper (Cu), and alloys thereof.

The second electrode layer 1310 includes a second connection portion 1311, a fifth band portion 1312, a sixth band portion 1313, a seventh band portion 1314, an eighth band portion 1315, a fifth corner portion 1316, a sixth corner portion 1317, a seventh corner portion 1318, and an eighth corner portion 1319.

The second connection portion 1311 covers the fourth surface S4 of the body 110 and is electrically connected to the exposed ends of a plurality of second internal electrodes 160.

The fifth band portion 1312 extends from the second connection portion 1311 to cover a portion of the first surface S1 of the body 110, and the sixth band portion 1313 extends from the second connection portion 1311 to cover a portion of the second surface S2 of the body 110.

The seventh band portion 1314 extends from the second connection portion 1311 to cover a portion of the fifth surface S5 of the body 110, and the eighth band portion 1315 extends from the second connection portion 1311 to cover a portion of the sixth surface S6 of the body 110.

The fifth conductive resin layer 1320 covers the fifth band portion 1312 and exposes the second connection portion 1311. For example, the fifth conductive resin layer 1320 may cover part or all of the fifth band portion 1312. Additionally, the fifth conductive resin layer 1320 may cover a portion of the first surface S1 of the body 110.

The sixth conductive resin layer 1330 covers the sixth band portion 1313 and exposes the second connection portion 1311. For example, the sixth conductive resin layer 1330 may cover part or all of the sixth band portion 1313. Additionally, the sixth conductive resin layer 1330 may cover a portion of the second surface S2 of the body 110.

The fifth conductive resin layer 1320 may include metal and resin.

For example, the metal included in the fifth conductive resin layer 1320 may include copper (Cu), silver (Ag), nickel (Ni), tin (Sn) or an alloy thereof.

For example, the resin included in the fifth conductive resin layer 1320 may be various known thermosetting resins, such as epoxy resin, phenol resin, urethane resin, silicone resin, and polyimide resin.

The sixth conductive resin layer 1330, the seventh conductive resin layer 1340, and the eighth conductive resin layer 1350 include the same or similar components as the fifth conductive resin layer 1320 described above, and thus, a repeated description thereof will be omitted.

The second external electrode 1300 corresponds to the first external electrode 1200 except for its location, so a redundant description of the remaining components will be omitted.

Hereinbelow, specific examples of the disclosure are presented. However, the examples described below are only for illustrating or explaining the disclosure in detail, and the scope of the disclosure should not be limited.

### Preparation Example: Manufacture of a Multilayer Ceramic Capacitor

A paste including barium titanate (BaTiO₃) powder was applied on a carrier film and dried to manufacture a plurality of dielectric green sheets.

A conductive paste including nickel (Ni) was applied on the dielectric green sheet using screen printing to form a conductive paste layer.

A plurality of dielectric green sheets was stacked such that at least portions of the conductive paste layers overlap each other, to manufacture a dielectric green sheet stack.

After cutting the dielectric green sheet stack into individual chips, debinding was performed by maintaining the individual chips at 350° C. for 66 hours in an air atmosphere, and firing was performed at 1165° C. to manufacture a body.

A paste including a glass frit and copper (Cu) was applied to an outer surface of the body by dipping, dried, and then fired to form an electrode layer.

The body was dipped into a conductive resin composition including an epoxy resin, tin (Sn), bismuth (Bi), and copper (Cu).

The conductive resin composition was removed from the first and second surfaces of the body using a porous non-woven fabric, and then cured to form a conductive resin layer.

Thereafter, nickel (Ni) and tin (Sn) plating was performed, and heat treatment was performed at 160° C. for 1 hour to manufacture a multilayer ceramic capacitor.

### Experimental Example: Whether Plating Breakage Occurs

After peeling off the tin (Sn) plating layer from the width direction (W) and thickness direction (T) surface of the external electrode of the sample and taking a scanning electron microscope of the corresponding surface, it was determined that “plating breakage” had occurred if the maximum length of the exposed portion of the first electrode layer on the surface of the external electrode was 30 μm or more. For thirty (30) samples per sample number, cases where plating breakage occurred (NG) and cases where it did not occur (OK) were indicated.

Meanwhile, for each sample, the external electrode was cut in the length direction (L) and thickness direction (T), and then the central portion of the external electrode was photographed using a scanning electron microscope for each sample. Thereafter, using the ImageJ program, a measurement area E having a length of 250 μm in the thickness direction (T) and a length of 20 μm in the length direction (L) was obtained based on a central point of the first external electrode in the thickness direction (T) and length direction (L) shown in the cross-sectional photograph described above. The measurement area E was marked in black and white using the ImageJ program. The electrode layer and the plating layer were marked in white, and the metal particles (or resin layer) that are present between the electrode layer and the plating layer were marked in black. The region marked in black was projected in a direction perpendicular to the length of the measurement region E. Thereafter, the sum of the lengths of the projected portions divided by the total length of the measurement area E was taken as the length ratio of the conductive inclusion.

The results of the foregoing observations are shown in Table 1.

TABLE 1

| | Length ratio of conductive | Whether plating breakage |
|---|---|---|
| Sample | inclusion (%) | occurs |
| 1 | 5.89 | OK |
| 2 | 13.58 | OK |
| 3 | 24.74 | OK |
| 4 | 38.02 | OK |
| 5 | 50.29 | OK |
| 6 | 51.85 | OK |
| 7 | 59.06 | OK |
| 8 | 65.56 | OK |
| 9 | 67.54 | OK |
| 10 | 68.94 | OK |
| 11 | 75.68 | OK |
| 12 | 77.92 | OK |
| 13 | 80.85 | OK |
| 14 | 81.99 | OK |
| 15 | 83.52 | OK |
| 16 | 84.86 | OK |
| 17* | 85.14 | NG |
| 18* | 85.64 | NG |
| 19* | 87.83 | NG |

*is Comparative Example

Referring to Table 1, it is confirmed that for samples 1-16, the length ratio of the conductive inclusion was 84.86% or less and no plating breakage occurred. For samples 17-19, it is confirmed that the length ratio of the conductive inclusion exceeded 84.86% and plating breakages occurred. When the length ratio of the conductive inclusion exceeds 84.86%, it appears that the conductive inclusion covers most of the electrode layer or protrudes too much from the electrode layer, thereby causing plating breakages.

Although the embodiment of the disclosure has been described above, the disclosure is not limited thereto, and it is possible to carry out various modifications within the claim coverage, the description of the present disclosure, and the accompanying drawings, and such modifications also fall within the scope of the disclosure.

### DESCRIPTION OF SYMBOLS

1000: multilayer ceramic capacitor
110: body
200: first external electrode
210: first electrode layer
230: first plating layer
250: first conductive inclusion
300: second external electrode
310: second electrode layer
330: second plating layer
350: second conductive inclusion
140: dielectric layer
143: first cover layer
145: second cover layer
150: first internal electrode
160: second internal electrode

What is claimed is:

1. A multilayer ceramic capacitor comprising:
a body comprising a plurality of internal electrodes and a dielectric layer disposed between the plurality of internal electrodes; and
an external electrode disposed outside of the body,
wherein the external electrode comprises:
an electrode layer connected to the plurality of internal electrodes and comprising a first metal and glass;
a plating layer disposed on the electrode layer; and
a conductive inclusion disposed at a part of an interface between the electrode layer and the plating layer.

2. The multilayer ceramic capacitor of claim 1, wherein
the conductive inclusion has an island shape.

3. The multilayer ceramic capacitor of claim 1, wherein
the conductive inclusion comprises a metal particle or a metal layer.

4. The multilayer ceramic capacitor of claim 3, wherein
the metal particle or the metal layer comprises a second metal.

5. The multilayer ceramic capacitor of claim 1, wherein
the conductive inclusion comprises an intermetallic compound.

6. The multilayer ceramic capacitor of claim 1, wherein:
the conductive inclusion comprises a conductive connection portion including a metal particle or a metal layer, and a first interface layer disposed at an interface of the conductive connection portion and the plating layer; and
the first interface layer comprises a first intermetallic compound.

7. The multilayer ceramic capacitor of claim 6, wherein
the first intermetallic compound comprises copper (Cu) and tin (Sn).

8. The multilayer ceramic capacitor of claim 7, wherein
the first intermetallic compound comprises Cu₆Sn₅ and/or Cu₃Sn.

9. The multilayer ceramic capacitor of claim 6, wherein
the first intermetallic compound comprises silver (Ag) and tin (Sn).

10. The multilayer ceramic capacitor of claim 9, wherein
the first intermetallic compound comprises Ag₃Sn.

11. The multilayer ceramic capacitor of claim 6, wherein
the first intermetallic compound comprises nickel (Ni) and tin (Sn).

12. The multilayer ceramic capacitor of claim 11, wherein
the first intermetallic compound comprises Ni₃Sn.

13. The multilayer ceramic capacitor of claim 1, wherein:
the conductive inclusion comprises a conductive connection portion including a metal particle or a metal layer, and a second interface layer disposed at an interface between the conductive connection portion and the electrode layer; and
the second interface layer comprises a second intermetallic compound.

14. The multilayer ceramic capacitor of claim 13, wherein
the second intermetallic compound comprises copper (Cu) and tin (Sn).

15. The multilayer ceramic capacitor of claim 14, wherein
the second intermetallic compound comprises Cu₆Sn₅ and/or Cu₃Sn.

16. The multilayer ceramic capacitor of claim 13, wherein
the second intermetallic compound comprises gold (Au) and tin (Sn).

17. The multilayer ceramic capacitor of claim 16, wherein
the second intermetallic compound comprises AuSn₄, AuSn₂ or AuSn.

18. The multilayer ceramic capacitor of claim 13, wherein
the second intermetallic compound comprises lead (Pb) and bismuth (Bi).

19. The multilayer ceramic capacitor of claim 18, wherein
the second intermetallic compound comprises Pb₇Bi₃.

20. The multilayer ceramic capacitor of claim 1, wherein
the conductive inclusion comprises a conductive connection portion including a metal particle or a metal layer, and a resin in contact with the conductive connection portion.

21. The multilayer ceramic capacitor of claim 20, wherein
the conductive connection portion is dispersed in the resin.

22. The multilayer ceramic capacitor of claim 1, wherein
a length ratio of the conductive inclusion is greater than 0% and less than or equal to 84.86%,
wherein the length ratio is a ratio a length of the conductive inclusion to a length of an interface between the first electrode layer and the plating layer.

23. The multilayer ceramic capacitor of claim 1, wherein:
the body comprises a first surface and a second surface opposite each other in a first direction intersecting the plurality of internal electrodes; and
the electrode layer comprises a connection portion connected to the plurality of internal electrodes, and a band portion extending from the connection portion and covering a portion of the first surface and a portion of the second surface.

24. The multilayer ceramic capacitor of claim 23, wherein:
the external electrode further comprises a conductive resin layer covering at least a portion of the band portion; and
the plating layer covers the conductive resin layer.

25. The multilayer ceramic capacitor of claim 24, wherein:
the electrode layer comprises two of the band portions,
the electrode layer comprises a corner portion where the connection portion and the two of the band portions adjacent to the connection portion are connected to each other; and
the conductive resin layer covers the corner portion.

26. The multilayer ceramic capacitor of claim 25, wherein
the external electrode further comprises a residual conductive resin layer disposed in an island shape on the connection portion.

27. The multilayer ceramic capacitor of claim 25, wherein
when a surface of the connection portion is uniformly divided into nine regions, the conductive resin layer covers at least a portion of the connection portion in the region including the corner portion.

28. The multilayer ceramic capacitor of claim 24, wherein
the conductive resin layer extends from the band portion onto the connection portion and covers a portion of the connection portion.

29. The multilayer ceramic capacitor of claim 23, wherein:
when a surface of the connecting portion is uniformly divided into nine regions, the conductive resin layer covers at least a portion of the connecting portion in the remaining regions except for a central region.

30. A multilayer ceramic capacitor comprising:
a body comprising a plurality of internal electrodes and a plurality of dielectric layers stacked in a first direction; and
an external electrode disposed on an outer surface of the body,
wherein the external electrode comprises:
an electrode layer connected to the plurality of internal electrodes and having a recess on a surface of the electrode layer;
a conductive inclusion filling the recess; and
a plating layer covering the electrode layer and the conductive inclusion.

31. The multilayer ceramic capacitor of claim 30, wherein
in a cross-section along the first direction,
the conductive inclusion comprises,
an inner portion in contact with the electrode layer and an outer portion in contact with the plating layer, with reference to a straight line connecting a first point and a second point where the electrode layer, the plating layer, and the conductive inclusion meet each other,
wherein an area of the inner portion is larger than an area of the outer portion.

32. The multilayer ceramic capacitor of claim 30, wherein
in a cross-section along the first direction,
the conductive inclusion comprises,
an inner portion in contact with the electrode layer and an outer portion in contact with the plating layer, with reference to a straight line connecting a first point and a second point where the electrode layer, the plating layer, and the conductive inclusion meet each other,
wherein a maximum distance between the straight line and an edge of the inner portion is greater than a maximum distance between the straight line and an edge of the outer portion.
